(19) United States
(12) Patent Application Publication
(10) Pub. No.: US 2018/0255606 A1
(43) Pub. Date: Sep. 6, 2018

(54) METHOD FOR UPDATING SYSTEM INFORMATION IN WIRELESS COMMUNICATION SYSTEM AND APPARATUS THEREFOR

(71) Applicant: LG ELECTRONICS INC., Seoul (KR)

(72) Inventors: Jaewook LEE, Seoul (KR); Youngdae LEE, Seoul (KR); Sunghoon JUNG, Seoul (KR)

(73) Assignee: LG ELECTRONICS INC., Seoul (KR)

(21) Appl. No.: 15/758,704

(22) PCT Filed: Sep. 30, 2016
(86) PCT No.: PCT/KR2016/010977

§ 371 Date: Mar. 8, 2018

Related U.S. Application Data
(60) Provisional application No. 62/237,595, filed on Oct. 6, 2015.

(51) Int. Cl. H04W 76/27; H04W 76/28; H04W 72/04; H04W 74/08; H04W 48/12; H04W 68/00

(52) U.S. Cl. CPC H04W 76/27; H04W 76/28; H04W 72/0406; H04W 88/16; H04W 48/12; H04W 68/005; H04W 74/0833

(57) ABSTRACT

A method for in a wireless communication system is disclosed. The method includes steps of receiving control information indicating a scheme for updating the system information; and updating the system information based on the control information, wherein the scheme for updating the system information comprises an immediate update scheme or a modification period based update scheme.

### TECHNICAL FIELD

The present invention relates to a wireless communication system and, more par-ticularly, to a method for updating system information in a wireless communication system and an apparatus therefor.

### BACKGROUND ART

As an example of a mobile communication system to which the present invention is applicable, a 3rd Generation Partnership Project Long Term Evolution (hereinafter, referred to as LTE) communication system is described in brief.

FIG. 1 is a view schematically illustrating a network structure of an E-UMTS as an exemplary radio communication system. An Evolved Universal Mobile Telecommu-nications System (E-UMTS) is an advanced version of a conventional Universal Mobile Telecommunications System (UMTS) and basic standardization thereof is currently underway in the 3GPP. E-UMTS may be generally referred to as a Long Term Evolution (LTE) system. For details of the technical specifications of the UMTS and E-UMTS, reference can be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells are present per eNB. A cell is configured to use one of bandwidths of 1.44, 3, 5, 10, 15, and 20 MHz to provide a downlink or uplink transport service to several UEs. Different cells may be set to provide different bandwidths. The eNB controls data transmission and reception for a plurality of UEs. The eNB transmits downlink scheduling information with respect to downlink data to notify a corre-sponding UE of a time/frequency domain in which data is to be transmitted, coding, data size, and Hybrid Automatic Repeat and reQuest (HARQ)-related information. In addition, the eNB transmits uplink scheduling information with respect to uplink data to a corresponding UE to inform the UE of an available time/frequency domain, coding, data size, and HARQ-related information. An interface may be used to transmit user traffic or control traffic between eNBs. A Core Network (CN) may include the AG, a network node for user registration of the UE, and the like. The AG manages mobility of a UE on a Tracking Area (TA) basis, each TA including a plurality of cells.

Although radio communication technology has been developed up to LTE based on Wideband Code Division Multiple Access (WCDMA), demands and expectations of users and providers continue to increase. In addition, since other radio access tech-nologies continue to be developed, new advances in technology are required to secure future competitiveness. For example, decrease of cost per bit, increase of service availability, flexible use of a frequency band, simple structure, open interface, and suitable power consumption by a UE are required.

### Disclosure of Invention Technical Problem

Based on the above discussion, the present invention proposes a method for updating system information in a wireless communication system and an apparatus therefor.

### Solution to Problem

In accordance with an embodiment of the present invention, a method for in a wireless communication system is disclosed. Especially, the method includes steps of receiving control information indicating a scheme for updating the system information; and updating the system information based on the control information, wherein the scheme for updating the system information comprises an immediate update scheme or a modification period based update scheme

Further, in accordance with an embodiment of the present invention, a user equipment (UE) in a wireless communication system is disclosed. The UE includes a radio frequency (RF) unit; and a processor configured to process signals, wherein the processor receives control information indicating a scheme for updating system in-formation, and updates the system information based on the control information, wherein the scheme for updating the system information comprises an immediate update scheme or a modification period based update scheme.

Preferably, the control information comprises an indicator indicating the system information to be updated. More preferably, the indicator is a bitmap, each bit of the bitmap indicating whether corresponding system information is to be updated or not.

Further, the control information is received via a paging message or a SIB1 (system information block 1) message.

Preferably, if the scheme for updating the system information is the modification period based update scheme, the UE determines whether the system information is to be updated or not by using an integer value included in the control information. More preferably, if the integer value is different from a specific stored value, updating the system information in a next modification period.

It is to be understood that both the foregoing general description and the following detailed description of the present invention are exemplary and explanatory and are intended to provide further explanation of the invention as claimed.

### Advantageous Effects of Invention

According to embodiments of the present invention, the UE can update system information efficiently in the wireless communication system.

It will be appreciated by persons skilled in the art that that the effects that can be achieved through the present invention are not limited to what has been particularly described hereinabove and other advantages of the present invention will be more clearly understood from the following detailed description.

### BRIEF DESCRIPTION OF DRAWINGS

The accompanying drawings, which are included to provide a further understanding of the invention and are incorporated in and constitute a part of this application, il-lustrate embodiment(s) of the invention and together with the description serve to explain the principle of the invention.

In the drawings:

FIG. 1 is a diagram showing a network structure of an Evolved Universal Mobile Telecommunications System (E-UMTS) as an example of a wireless communication system.

FIG. 2 is a diagram conceptually showing a network structure of an evolved universal terrestrial radio access network (E-UTRAN).

FIG. 3 is a diagram showing a control plane and a user plane of a radio interface protocol between a UE and an E-UTRAN based on a 3rd generation partnership project (3GPP) radio access network standard.

FIG. 4 is a diagram showing physical channels used in a 3GPP system and a general signal transmission method using the same.

FIG. 5 is a diagram showing the structure of a radio frame used in a Long Term Evolution (LTE) system.

FIG. 6 is a diagram showing a general transmission and reception method using a paging message.

FIG. 7 is a diagram showing general principles related to a change of system in-formation.

FIG. 8 is a diagram showing an example for updating system information in ac-cordance with an embodiment of the present invention.

FIG. 9 is a diagram showing another example for updating system information in accordance with an embodiment of the present invention.

FIG. 10 is a block diagram of a communication apparatus according to an em-bodiment of the present invention.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, structures, operations, and other features of the present invention will be readily understood from the embodiments of the present invention, examples of which are illustrated in the accompanying drawings. Embodiments which will be described hereinbelow are examples in which technical features of the present invention are applied to a 3GPP system.

Although the embodiments of the present invention will be described based on an LTE system and an LTE-advanced (LTE-A) system, the LTE system and the LTE-A system are purely exemplary and the embodiments of the present invention can be applied to any communication system corresponding to the aforementioned definition. In addition, although the embodiments of the present invention will be described based on frequency division duplexing (FDD), the FDD mode is purely exemplary and the embodiments of the present invention can easily be applied to half-FDD (H-FDD) or time division duplexing (TDD) with some modifications.

In the present disclosure, a base station (eNB) may be used as a broad meaning including a remote radio head (RRH), an eNB, a transmission point (TP), a reception point (RP), a relay, etc.

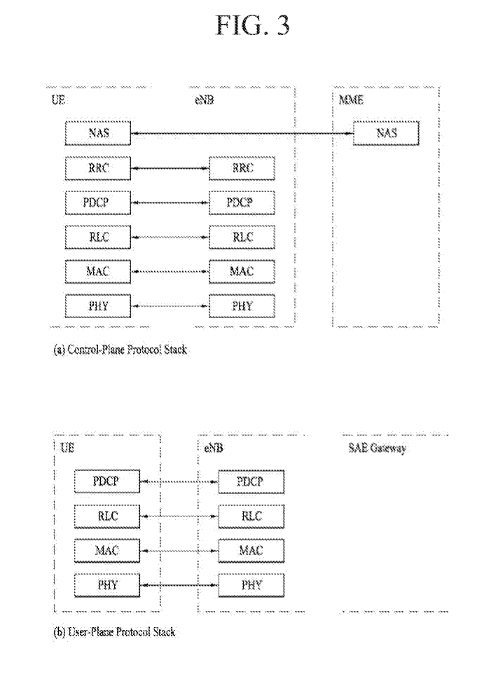

FIG. 2 is a diagram conceptually showing a network structure of an evolved universal terrestrial radio access network (E-UTRAN). An E-UTRAN system is an evolved form of a legacy UTRAN system. The E-UTRAN includes cells (eNB) which are connected to each other via an X2 interface. A cell is connected to a user equipment (UE) via a radio interface and to an evolved packet core (EPC) via an S1 interface.

The EPC includes a mobility management entity (MME), a serving-gateway (S-GW), and a packet data network-gateway (PDN-GW). The MME has information about con-nections and capabilities of UEs, mainly for use in managing the mobility of the UEs. The S-GW is a gateway having the E-UTRAN as an end point, and the PDN-GW is a gateway having a packet data network (PDN) as an end point.

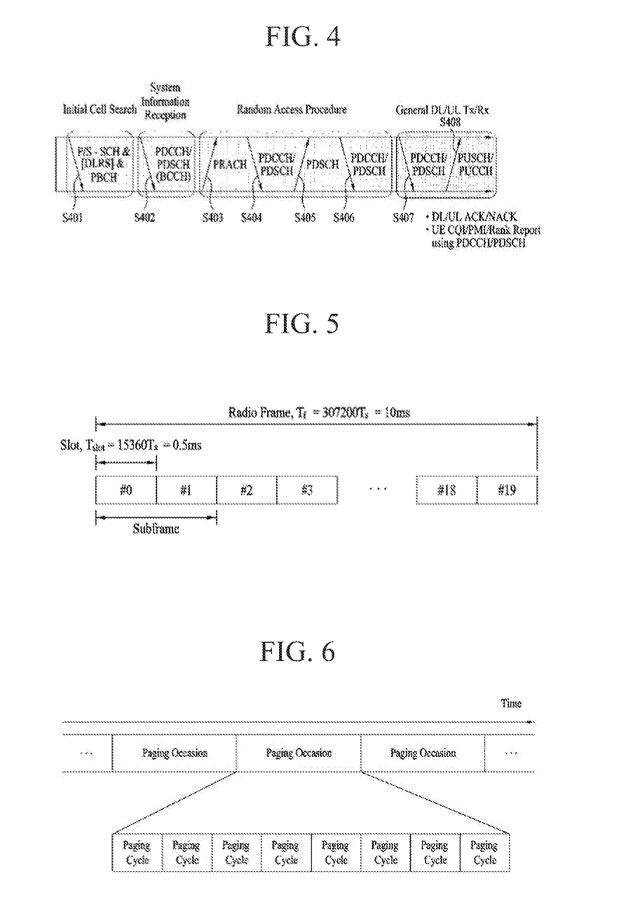

FIG. 3 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

A physical (PHY) layer of a first layer provides an information transfer service to a higher layer using a physical channel. The PHY layer is connected to a medium access control (MAC) layer located on the higher layer via a transport channel. Data is transported between the MAC layer and the PHY layer via the transport channel. Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink.

The MAC layer of a second layer provides a service to a radio link control (RLC) layer of a higher layer via a logical channel. The RLC layer of the second layer supports reliable data transmission. A function of the RLC layer may be implemented by a functional block of the MAC layer. A packet data convergence protocol (PDCP) layer of the second layer performs a header compression function to reduce un-necessary control information for efficient transmission of an Internet protocol (IP) packet such as an IP version 4 (IPv4) packet or an IP version 6 (IPv6) packet in a radio interface having a relatively small bandwidth.

A radio resource control (RRC) layer located at the bottom of a third layer is defined only in the control plane. The RRC layer controls logical channels, transport channels, and physical channels in relation to configuration, re-configuration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other.

One cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

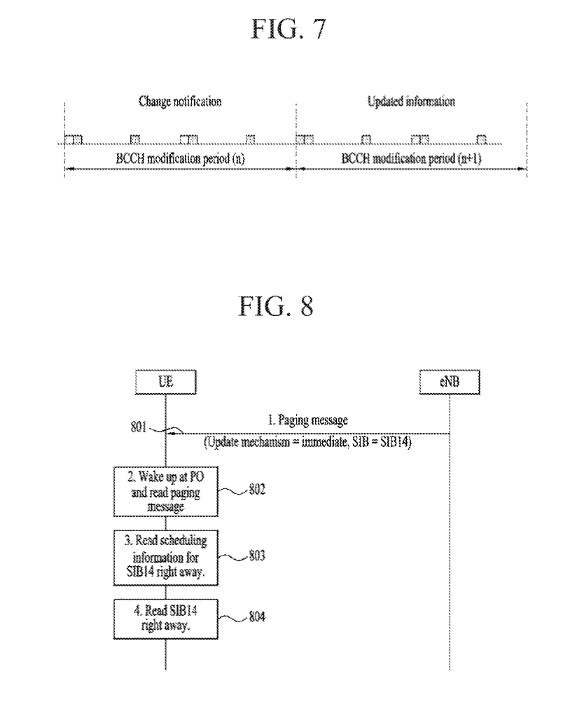

FIG. 4 is a diagram showing physical channels used in a 3GPP system and a general signal transmission method using the same.

When a UE is powered on or enters a new cell, the UE performs an initial cell search operation such as synchronization with an eNB (S401). To this end, the UE may receive a primary synchronization channel (P-SCH) and a secondary synchronization channel (S-SCH) from the eNB to perform synchronization with the eNB and acquire information such as a cell ID. Then, the UE may receive a physical broadcast channel from the eNB to acquire broadcast information in the cell. During the initial cell search operation, the UE may receive a downlink reference signal (DL RS) so as to confirm a downlink channel state.

After the initial cell search operation, the UE may receive a physical downlink control channel (PDCCH) and a physical downlink control channel (PDSCH) based on information included in the PDCCH to acquire more detailed system information (S402).

When the UE initially accesses the eNB or has no radio resources for signal transmission, the UE may perform a random access procedure (RACH) with respect to the eNB (steps S403 to S406). To this end, the UE may transmit a specific sequence as a preamble through a physical random access channel (PRACH) (S403) and receive a response message to the preamble through the PDCCH and the PDSCH corresponding thereto (S404). In the case of contention-based RACH, the UE may further perform a contention resolution procedure.

After the above procedure, the UE may receive PDCCH/PDSCH from the eNB (S407) and may transmit a physical uplink shared channel (PUSCH)/physical uplink control channel (PUCCH) to the eNB (S408), which is a general uplink/downlink signal transmission procedure. Particularly, the UE receives downlink control in-formation (DCI) through the PDCCH. Here, the DCI includes control information such as resource allocation information for the UE. Different DCI formats are defined according to different usages of DCI.

Control information transmitted from the UE to the eNB in uplink or transmitted from the eNB to the UE in downlink includes a downlink/uplink acknowledge/negative acknowledge (ACK/NACK) signal, a channel quality indicator (CQI), a precoding matrix index (PMI), a rank indicator (RI), and the like. In the case of the 3GPP LTE system, the UE may transmit the control information such as CQI/PMI/RI through the PUSCH and/or the PUCCH.

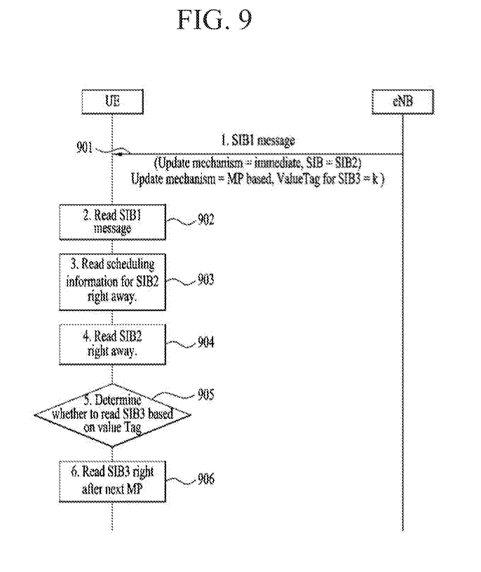

FIG. 5 is a diagram showing the structure of a radio frame used in an LTE system.

Referring to FIG. 5, the radio frame has a length of 10 ms (327200×Ts) and is divided into 10 subframes having the same size. Each of the subframes has a length of 1 ms and includes two slots. Each of the slots has a length of 0.5 ms (15360×Ts). Ts denotes a sampling time, and is represented by Ts=1/(15 kHz×2048)=3.2552×10−8 (about 33 ns). Each of the slots includes a plurality of OFDM symbols in a time domain and a plurality of Resource Blocks (RBs) in a frequency domain. In the LTE system, one RB includes 12 subcarriers×7 (or 6) OFDM symbols. A transmission time interval (TTI) that is a unit time for transmission of data may be determined in units of one or more subframes. The structure of the radio frame is purely exemplary and thus the number of subframes included in the radio frame, the number of slots included in a subframe, or the number of OFDM symbols included in a slot may be changed in various ways.

Hereinafter, an RRC state of a UE and an RRC connection method will be described.

The RRC state indicates whether the RRC layer of the UE is logically connected to the RRC layer of the E-UTRAN. When the RRC connection is established, the UE is in a RRC_CONNECTED state. Otherwise, the UE is in a RRC_IDLE state.

The E-UTRAN can effectively control UEs because it can check the presence of RRC_CONNECTED UEs on a cell basis. On the other hand, the E-UTRAN cannot check the presence of RRC_IDLE UEs on a cell basis and thus a CN manages RRC_IDLE UEs on a TA basis. A TA is an area unit larger than a cell. That is, in order to receive a service such as a voice service or a data service from a cell, the UE needs to transition to the RRC_CONNECTED state.

In particular, when a user initially turns a UE on, the UE first searches for an appropriate cell and camps on the cell in the RRC_IDLE state. The RRC_IDLE UE transitions to the RRC_CONNECTED state by performing an RRC connection estab-lishment procedure only when the RRC_IDLE UE needs to establish an RRC connection. For example, when uplink data transmission is necessary due to call connection attempt of a user or when a response message is transmitted in response to a paging message received from the E-UTRAN, the RRC_IDLE UE needs to be RRC connected to the E-UTRAN.

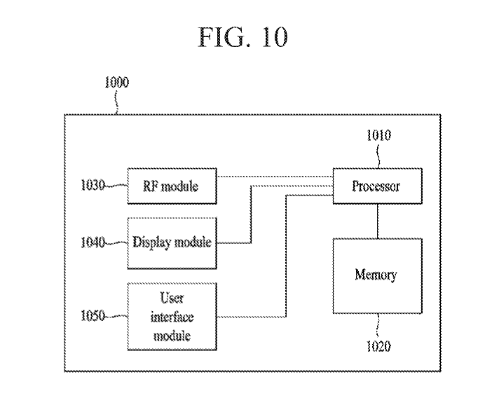

FIG. 6 is a diagram showing a general transmission and reception method using a paging message.

Referring to FIG. 6, the paging message includes a paging record having paging cause and UE identity. Upon receiving the paging message, the UE may perform a dis-continuous reception (DRX) operation in order to reduce power consumption.

In detail, a network configures a plurality of paging occasions (POs) in every time cycle called a paging DRC cycle and a specific UE receives only a specific paging occasion and acquires a paging message. The UE does not receive a paging channel in paging occasions other than the specific paging occasion and may be in a sleep state in order to reduce power consumption One PO is a subframe where there may be P-RNTI transmitted on PDCCH addressing the paging message. One Paging Frame (PF) is one Radio Frame, which may contain one or multiple Paging Occasion(s). When DRX is used the UE needs only to monitor one PO per DRX cycle.

The eNB and the UE use a paging indicator (PI) as a specific value indicating transmission of a paging message. The eNB may define a specific identity (e.g., paging
radio network temporary identity (P-RNTI)) as the PI and inform the UE of paging information transmission. For example, the UE wakes up in every DRX cycle and receives a subframe to determine the presence of a paging message directed thereto. In the presence of the P-RNTI on an L1/L2 control channel (a PDCCH) in the received subframe, the UE is aware that a paging message exists on a PDSCH of the subframe. When the paging message includes an ID of the UE (e.g., an international mobile subscriber identity (IMSI)), the UE receives a service by responding to the eNB (e.g., establishing an RRC connection or receiving system information).

More specifically, PF and PO is determined by following formulae using the DRX parameters provided in System Information:

PF is given by following equation:

SFN mod T=(T div N)*(UE_ID mod N)

Index i_s pointing to PO from subframe pattern defined in following tables 1 and 2 will be derived from following calculation:

i_s=floor(UE_ID/N)mod Ns

Table 1

TABLE 1

| | PO when | PO when | PO when | PO when |
|---|---|---|---|---|
| Ns | i_s = 0 | i_s = 1 | i_s = 2 | i_s = 3 |
| 1 | 9 | N/A | N/A | N/A |
| 2 | 4 | 9 | N/A | N/A |
| 4 | 0 | 4 | 5 | 9 |

Table 2

TABLE 2

| | PO when | PO when | PO when | PO when |
|---|---|---|---|---|
| Ns | i_s = 0 | i_s = 1 | i_s = 2 | i_s = 3 |
| 1 | 0 | N/A | N/A | N/A |
| 2 | 0 | 5 | N/A | N/A |
| 4 | 0 | 1 | 5 | 6 |

System Information DRX parameters stored in the UE shall be updated locally in the UE whenever the DRX parameter values are changed in SI. If the UE has no IMSI, for instance when making an emergency call without USIM, the UE shall use as default identity UE_ID=0 in the PF and i_s formulas above.

The following Parameters are used for the calculation of the PF and i_s:
T: DRX cycle of the UE. T is determined by the shortest of the UE specific DRX value, if allocated by upper layers, and a default DRX value broadcast in system in-formation. If UE specific DRX is not configured by upper layers, the default value is applied.
nB: 4T, 2T, T, T/2, T/4, T/8, T/16, T/32.
N: min(T,nB)
Ns: max(1,nB/T)
UE_ID: IMSI mod 1024.

IMSI is given as sequence of digits of type Integer (0 . . . 9), IMSI shall in the formulae above be interpreted as a decimal integer number, where the first digit given in the sequence represents the highest order digit.

For example, IMSI=12 (digitl=1, digit2=2)

In the calculations, this shall be interpreted as the decimal integer “12”, not “1×16+2=18”.

In the following description, system information is explained. First of all, the system information should contain necessary information a user equipment should be aware of to access a base station. Therefore, the user equipment should receive all system in-formation before accessing the base station and should have latest system information all the time. Since all user equipments in a cell should be aware of the system in-formation, the base station periodically transmits the system information.

System information can be divided into MIB (Master Information Block), SB (Scheduling Block) and SIB (System Information Block). The MIB enables a user equipment to recognize such a physical configuration of a corresponding cell as a bandwidth and the like. The SB indicates such transmission information of SIBs as a transmission cycle and the like. In this case, the SIB is an aggregate of system in-formations related to each other. For instance, a specific SIB contains information of a neighbor cell only and another SIB just contains information of a UL radio channel used by a user equipment.

In the following description, a BCCH (broadcast control channel) Modification Period is explained.

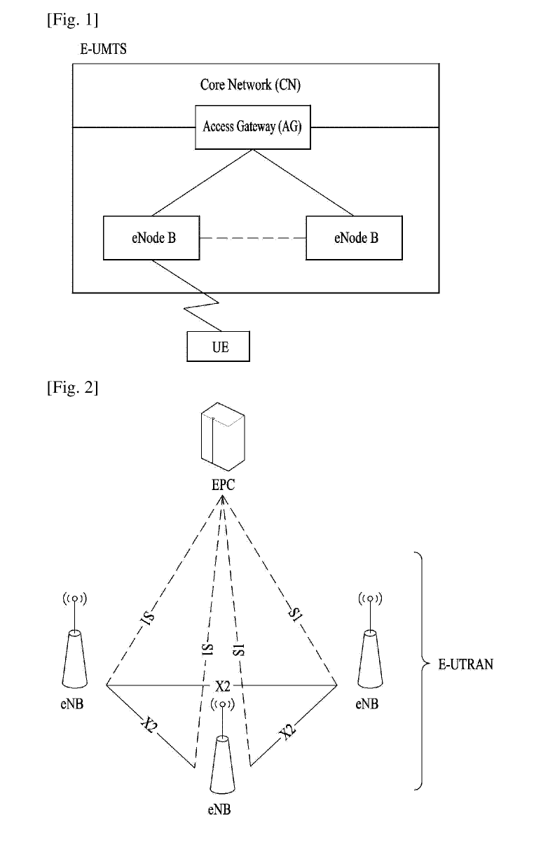

FIG. 7 is a diagram showing general principles related to a change of system in-formation.

Change of system information only occurs at specific radio frames, i.e. the concept of a modification period is used. System information may be transmitted a number of times with the same content within a modification period, as defined by its scheduling. The modification period boundaries are defined by SFN values for which SFN mod m=0, where m is the number of radio frames comprising the modification period. The modification period is configured by system information.

When the network changes (some of the) system information, it first notifies the UEs about this change, i.e. this may be done throughout a modification period. In the next modification period, the network transmits the updated system information. These general principles are illustrated in FIG. 7. Upon receiving a change notification, the UE acquires the new system information immediately from the start of the next modi-fication period. The UE applies the previously acquired system information until the UE acquires the new system information.

The Paging message is used to inform UEs in RRC_IDLE and UEs in RRC_CONNECTED about a system information change. If the UE receives a Paging message including the systemInfoModification, the UE knows that the system in-formation will change at the next modification period boundary. Although the UE may be informed about changes in system information, no further details are provided e.g. regarding which system information will change.

More specifically, upon receiving the Paging message, if in RRC_IDLE, for each of the PagingRecord, if any, included in the Paging message and if the ue-Identity included in the PagingRecord matches one of the UE identities allocated by upper layers, the UE shall forward the ue-Identity and the cn-Domain to the upper layers. Further, upon receiving the Paging message, if the systemInfoModification is included, the UE shall re-acquire the required system information using the system information acquisition procedure.

Furthermore, SystemInformationBlockType1 includes a value tag, systemInfoValueTag, that indicates if a change has occurred in the SI messages. UEs may use systemInfoValueTag, e.g., upon return from out of coverage, to verify if the previously stored SI messages are still valid. Additionally, the UE considers stored system in-formation to be invalid after 3 hours from the moment it was successfully confirmed as valid, unless specified otherwise.

E-UTRAN may not update systemInfoValueTag upon change of some system information e.g., ETWS (Earthquake and Tsunami Warning System) information, regularly changing parameters. Similarly, E-UTRAN may not include the systemInfo-Modification within the Paging message upon change of some system information.

The UE verifies that stored system information remains valid by either checking systemInfoValueTag in SystemInformationBlockType1 after the modification period boundary, or attempting to find the systemInfoModification indication at least modifi-cation PeriodCoeff times during the modification period in case no paging is received, in every modification period. If no paging message is received by the UE during a modification period, the UE may assume that no change of system information will occur at the next modification period boundary. If UE in RRC_CONNECTED, during a modification period, receives one paging message, it may deduce from the presence/absence of systemInfoModification whether a change of system information other than ETWS information will occur in the next modification period or not.

ETWS capable UEs in RRC_CONNECTED shall attempt to read paging at least once every default PagingCycle to check whether ETWS notification is present or not.

In some scenarios, the same system information needs to be updated fast and acquired by the UE fast enough in order to cope with a surge of connection trial. In other scenarios, the same system information does not need to be updated fast. This situation needs to be under the control of the network. However, it is not possible as now.

In order to control the update speed of the broadcast information (e.g., system information), in this invention, the network controls how to update the broadcast in-formation and how the UE acquires updated broadcast information accordingly.

The control information on how to update the broadcast information and how the UE acquires updated broadcast information is provided in some messages by the network. For example, the above information is provided via a paging message. Or, the above information is provided via any first broadcast information required to acquire other broadcast information. The first broadcast information can be MIB (Master in-formation block), SIB1, SIB1 bis or new SIB. Or, the above information is provided via the PDCCH for paging or SI (system information) message.

Further, the control information includes at least one of information on how to update the broadcast information, information on which broadcast information is to be updated, and linkage between update mechanism and the applicable broadcast in-formation.

(1) As for the information on how to update the broadcast information, the in-formation can be one or more bits to indicate the update mechanism.

The example of how to update the broadcast information is that the update of the broadcast information is based on modification period as for SIB2, SIB3˜SIB9. The updated broadcast information is acquired in next modification period. If this type of update mechanism is indicated in control information, the UE tries to acquire the updated broadcast information in next modification period after reading the control information on how to update the broadcast information.

The another example of how to update the broadcast information is that the update of the broadcast information is based on immediate update regardless of modification period as in SIB10˜SIB14. If this type of update mechanism is indicated in control information, the UE tries to acquire the updated broadcast information right after reading the control information on how to update the broadcast information. In other words, right after reading the control information, the UE acquires the scheduling in-formation for broadcast information and acquires the broadcast information. If there is any uplink transmission data, right after reading the control information, the UE acquires the scheduling information for broadcast information and acquires the broadcast information before establishing RRC connection.

Another example of how to update the broadcast information is that the update of the broadcast information is based on on-demand method. On-demand method means that the UE requests the provision of a certain broadcast information to the network and the network provides the requested broadcast information to the UE via dedicated/broadcast signaling.

The time offset information can be also provided. If time offset information is provided, the UE acquires the all (or updated) broadcast information after the indicated time offset. Other update mechanism can also be indicated.

(2) The information on which broadcast information is to be updated as follows.
The indication of updated broadcast information can be provided. For example, the indication indicating SIB10, SIB11 and SIB12 are provided as updated broadcast in-formation.
The bitmap for each broadcast information can be provided. For example, the bitmap of length 3 for broadcast information 1, broadcast information 2, and broadcast information 3. The value ‘0’ means the not to be changed and value ‘1’ means ‘to be changed’.
The integer value (e.g., valueTag in SIB1) can be provided for each applicable broadcast information or the integer value for all applicable broadcast information.

? Of course, any combination of above information can be provided.

(3) As for the linkage between update mechanism and the applicable broadcast information, the all broadcast information may be applicable or only a subset of broadcast information is applicable. For example, one update mechanism is provided for all applicable broadcast information. Or, for each applicable broadcast information, one update mechanism is provided. Further, for each update mechanism, the applicable broadcast information is provided.

After reading the control information, the UE tries to acquire all (or one or more updated) broadcast information according to the indicated updated mechanism as described above. In the above invention, the broadcast information can be system in-formation.

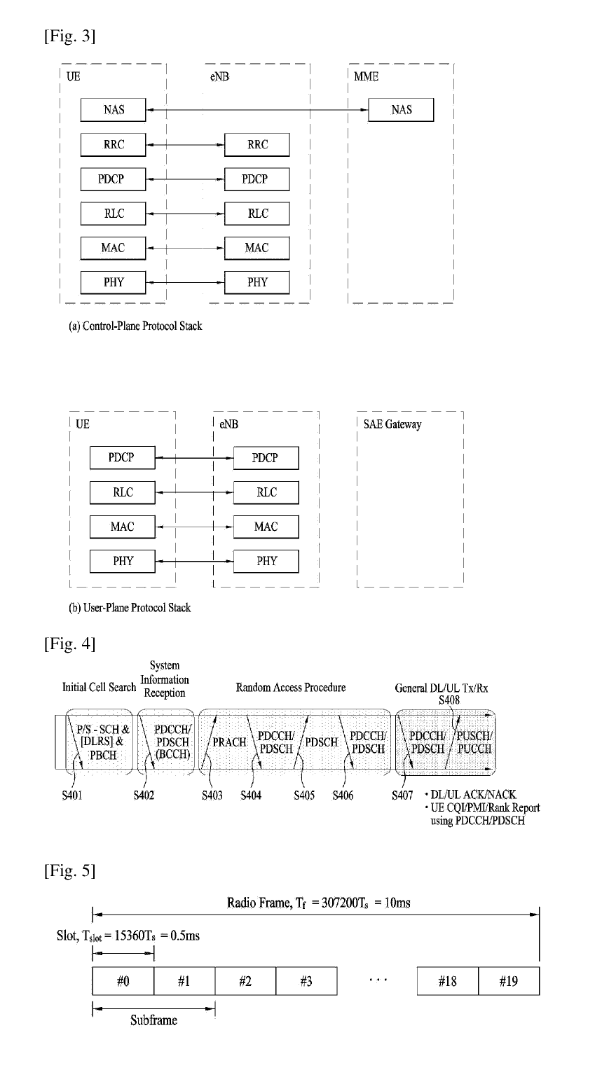

FIG. 8 is a diagram showing an example for updating system information in ac-cordance with an embodiment of the present invention. Especially, in FIG. 8, it is assumed that the control information for updating system information is provided via the paging message.

Referring to FIG. 8, in step 801, the UE is received the paging message including information on the information on how to update the broadcast information and the in-formation on which broadcast information is to be updated. Especially, in FIG. 8, the eNB instructs the UE to update SIB14 immediately via the paging message.

Next, the UE wakes up at a paging occasion (PO), and reads the paging message in step 802, and then reads the scheduling information for SIB14 right away in step 803.

Finally, in step 804, the UE reads and updates SIB14 immediately. That is, for updating SIB14 immediately, as soon as wakeup, the UE may performs procedures for reading SIB14.

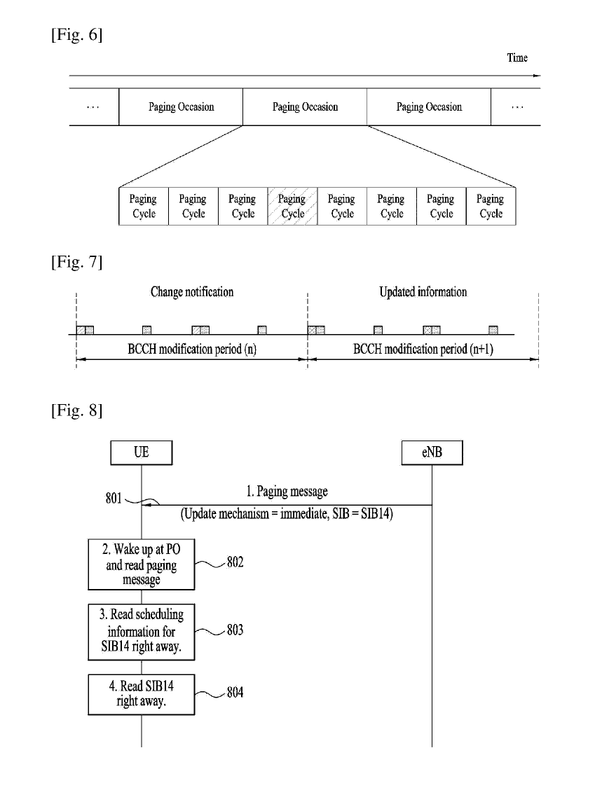

FIG. 9 is a diagram showing another example for updating system information in accordance with an embodiment of the present invention. Especially, in FIG. 9, it is assumed that the control information for updating system information is provided via SIB1.

Referring to FIG. 9, in step 901, the UE is received the SIB1 message including information on the information on how to update the broadcast information and the in-formation on which broadcast information is to be updated. Especially, in FIG. 9, the eNB instructs the UE to update SIB2 immediately and to update SIB3 based on modi-fication period by comparing the ValueTag, via the SIB1 message.

Next, the UE reads the SIB1 message in step 902, and then reads the scheduling information for SIB2 right away in step 903. And, in step 904, the UE reads and updates SIB2 immediately.

Further, in step 905, the UE determines whether to read SIB3 based on the ValueTag. In this case, since the valueTag included in SIB1 message is k, if stored valueTag is not k (i.e., the ValueTag is changed), SIB3 may be changed, thus the UE reads and updates SIB3 after next MP, in step 906. However, if the stored valueTag is k (i.e., the ValueTag is not changed), SIB3 is not changed, thus the UE is not required to updates SIB3.

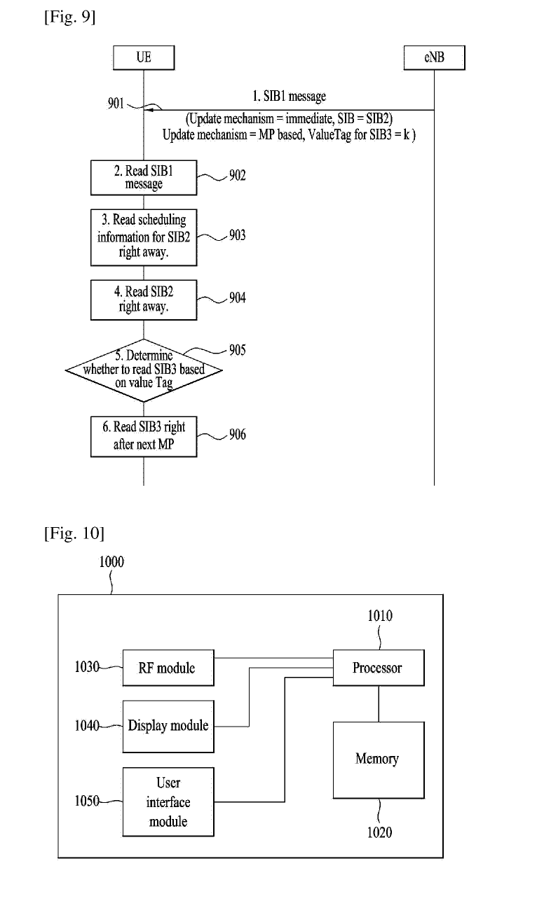

FIG. 10 is a block diagram illustrating a communication apparatus in accordance with an embodiment of the present invention.

Referring to FIG. 10, a communication device 1000 includes a processor 1010, a memory 1020, a Radio Frequency (RF) module 1030, a display module 1040, and a user interface module 1050.

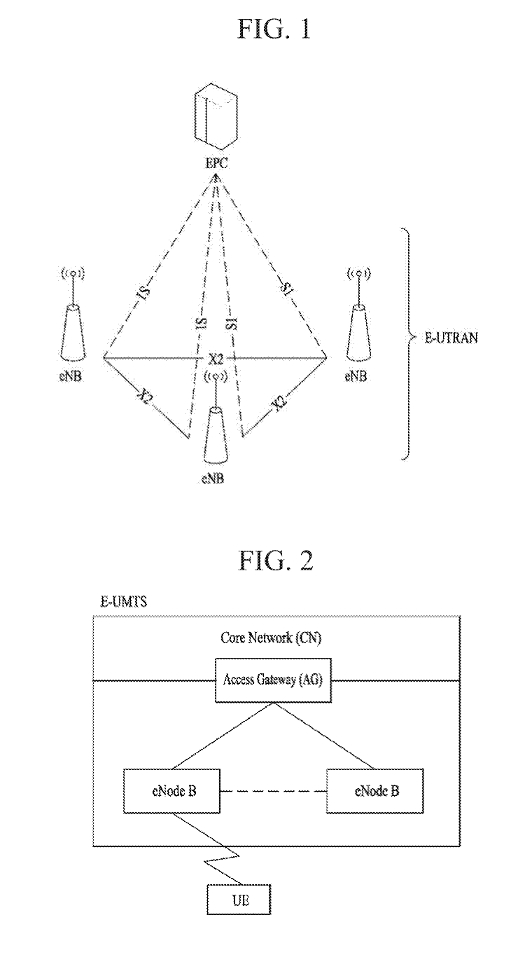

The communication device 1000 is illustrated for convenience of the description and some modules may be omitted. Moreover, the communication device 1000 may further include necessary modules. Some modules of the communication device 1000 may be further divided into sub-modules. The processor 1010 is configured to perform op-erations according to the embodiments of the present invention exemplarily described with reference to the figures. Specifically, for the detailed operations of the processor 1010, reference may be made to the contents described with reference to FIGS. 1 to 9.

The memory 1020 is connected to the processor 1010 and stores operating systems, applications, program code, data, and the like. The RF module 1030 is connected to the processor 1010 and performs a function of converting a baseband signal into a radio signal or converting a radio signal into a baseband signal. For this, the RF module

1030 performs analog conversion, amplification, filtering, and frequency upconversion or inverse processes thereof. The display module 1040 is connected to the processor 1010 and displays various types of information. The display module 1040 may include, but is not limited to, a well-known element such as a Liquid Crystal Display (LCD), a Light Emitting Diode (LED), or an Organic Light Emitting Diode (OLED). The user interface module 1050 is connected to the processor 1010 and may include a com-bination of well-known user interfaces such as a keypad and a touchscreen.

The above-described embodiments are combinations of elements and features of the present invention in a predetermined manner. Each of the elements or features may be considered selective unless otherwise mentioned. Each element or feature may be practiced without being combined with other elements or features. Further, an em-bodiment of the present invention may be constructed by combining parts of the elements and/or features. Operation orders described in embodiments of the present invention may be rearranged. Some constructions of any one embodiment may be included in another embodiment and may be replaced with corresponding con-structions of another embodiment. In the appended claims, it will be apparent that claims that are not explicitly dependent on each other can be combined to provide an embodiment or new claims can be added through amendment after the application is filed.

The embodiments according to the present invention can be implemented by various means, for example, hardware, firmware, software, or combinations thereof. In the case of a hardware configuration, the embodiments of the present invention may be im-plemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, con-trollers, microcontrollers, microprocessors, etc.

In the case of a firmware or software configuration, the method according to the embodiments of the present invention may be implemented by a type of a module, a procedure, or a function, which performs functions or operations described above. For example, software code may be stored in a memory unit and then may be executed by a processor. The memory unit may be located inside or outside the processor to transmit and receive data to and from the processor through various well-known means.

The present invention may be carried out in other specific ways than those set forth herein without departing from the spirit and essential characteristics of the present invention. The above embodiments are therefore to be construed in all aspects as il-lustrative and not restrictive. The scope of the invention should be determined by the appended claims and their legal equivalents and all changes coming within the meaning and equivalency range of the appended claims are intended to be embraced therein.

### INDUSTRIAL APPLICABILITY

While the above-described method for updating system information in a wireless communication system has been described centering on an example applied to the 3GPP LTE system, the present invention is applicable to a variety of wireless commu-nication systems in addition to the 3GPP LTE system.

What is claimed is:

1. A method for updating system information at a user equipment (UE) in a wireless communication system, the method comprising:
receiving control information indicating a scheme for updating the system information; and
updating the system information based on the control information, wherein the scheme for updating the system information comprises an immediate update scheme or a modification period based update scheme.

2. The method of claim 1, wherein the control information comprises an indicator indicating the system information to be updated.

3. The method of claim 2, wherein the indicator is a bitmap, each bit of the bitmap indicating whether corresponding system information is to be updated or not.

4. The method of claim 1, wherein the control information is received via a paging message or a SIB1 (system information block 1) message.

5. The method of claim 1, wherein, if the scheme for updating the system information is the modification period based update scheme, updating the system information comprises determining whether the system in-formation is to be updated or not by using an integer value included in the control information.

6. The method of claim 5, wherein, if the integer value is different from a specific stored value, updating the system information in a next modi-fication period.

7. A user equipment (UE) in a wireless communication system, the UE comprising:
a radio frequency (RF) unit; and
a processor configured to process signals,
wherein the processor receives control information indicating a scheme for updating system information, and updates the system information based on the control information,
wherein the scheme for updating the system information comprises an immediate update scheme or a modification period based update scheme.

8. The UE of claim 7, wherein the control information comprises an indicator indicating the system information to be updated.

9. The UE of claim 8, wherein the indicator is a bitmap, each bit of the bitmap indicating whether corresponding system information is to be updated or not.

10. The UE of claim 7, wherein the control information is received via a paging message or a SIB1 (system information block 1) message.

11. The UE of claim 7, wherein, if the scheme for updating the system in-formation is the modification period based update scheme, the processor determines whether the system information is to be updated or not by using an integer value included in the control information.

12. The UE of claim 11, wherein, if the integer value is different from a specific stored value, updating the system information in
